(19) United States
(12) Patent Application Publication
(10) Pub. No.: US 2026/0244412 A1
(43) Pub. Date: Aug. 20, 2026

(54) METHOD AND SYSTEM FOR AUTOMATED GENERATION OF DATA PIPELINE CODE USING ARTIFICIAL INTELLIGENCE (AI) AGENTS FIELD

(71) Applicant: LTI Mindtree Ltd, Mumbai (IN)

(72) Inventors: Tushar Madheshia, Mumbai (IN); Shivanand Pawar, Mumbai (IN); Ranganath Ramakrishna, Mumbai (IN)

(21) Appl. No.: 19/245,455

(22) Filed: Jun. 23, 2025

(30) Foreign Application Priority Data
Feb. 19, 2025 (IN) 202521014214

(51) Int. Cl. G06F 8/35; G06F 8/10; G10L 15/26

(52) U.S. Cl. CPC G06F 8/35; G06F 8/10; G10L 15/26

(57) ABSTRACT

A method and system for automated generation of data pipeline code is disclosed. Multi-modal input data comprising either a visual data, audio data, and textual data is received by the system. A hierarchical framework is instantiated, which comprises multiple specialized AI agents such as, a planner agent processes the multi-modal input data to extract structural elements defining a pipeline architecture. An assembler agent generates a pipeline configuration by incorporating database schema information into the extracted structural elements. A validator agent validates the pipeline configuration against predefined technical requirements and a code generator agent generates an executable DBT code implementing the validated pipeline configuration. A reflection agent executes the generated DBT code in an isolated environment before deployment to detect execution errors and a state agent accesses each agent to obtain agent state data to facilitate sequential processing of the pipeline code. s

### FIELD

Various embodiments of the present disclosure generally relate to data pipeline code. More particularly, the disclosure relates to a method and system for receiving multi-modal input and automatically generating executable data pipeline code using artificial intelligence (AI) agents.

### BACKGROUND

DBT (Data Build Tool) is an open-source analytics engineering framework that enables data teams to transform raw data within a data warehouse using SQL-based models. It simplifies data transformation workflows by allowing users to define, test, and document data models in a modular and version-controlled manner. DBT follows the ELT (Extract, Load, Transform) paradigm, leveraging the computational power of modern cloud data warehouses.

A DBT model is a SQL-based transformation layer within DBT that defines how raw data should be processed and structured into meaningful datasets. Models in DBT are written as SQL queries, typically in . SQL files, and are used to create tables or views within a data warehouse. The models follow a modular approach, allowing data engineers and analysts to build transformations incrementally, defines dependencies between models, and enables data consistency through automated testing and documentation.

Data teams face significant challenges in translating transformation requirements, which are often conveyed in various unstructured formats such as whiteboard sketches, verbal discussions, or written specifications, into a production-ready DBT model. The requirements typically lack standardization, making it difficult to ensure consistency and accuracy when defining data transformations. Additionally, the process of manually converting these high-level conceptual inputs into SQL-based DBT models requires substantial effort, technical expertise, and iterative refinements to align with business needs. Misinterpretations or ambiguities in initial requirements can lead to inefficiencies, necessitating frequent revisions and rework.

The process is inherently manual, requiring data engineers to interpret unstructured transformation requirements and translate them into DBT models using SQL, which increases the likelihood of errors and inconsistencies. The absence of automation means that any misinterpretation or ambiguity in the initial requirements can lead to incorrect transformations, necessitating multiple iterations and rework. Additionally, as data pipelines grow in complexity, managing dependencies between models, enabling data integrity, and maintaining up-to-date documentation becomes increasingly challenging. These inefficiencies slow down the overall data workflow, creating bottlenecks that hinder the agility of modern data-driven organizations. As a result, data teams spend a significant amount of time on repetitive tasks instead of focusing on higher-value analytical and strategic initiatives.

The existing approaches to creating data pipelines involve a labor-intensive and fragmented process that requires manually interpreting transformation requirements from disparate sources such as documents, diagrams, or verbal discussions. This necessitates an iterative back-and-forth between business stakeholders and data engineers to refine specifications, clarify ambiguities, and ensure that business logic is accurately captured in the pipeline design. Due to the lack of automation, pipeline development becomes a time-consuming and error-prone task, often requiring extensive debugging and modifications to align with evolving business needs. Additionally, rigorous validation is essential to confirm that the implemented pipeline correctly reflects the initial requirements, further prolonging the development cycle. Furthermore, expertise in DBT and SQL is required to construct efficient and maintainable transformations, limiting accessibility to only skilled data engineers and increasing dependency on specialized personnel. As a result, organizations face inefficiencies in scaling their data workflows, slowing down data-driven decision-making and increasing the overall cost of maintaining robust data pipelines.

Traditionally, data engineers write custom SQL-based transformation logic manually using tools like DBT, requiring a deep understanding of both business requirements and data warehouse optimizations. While visual workflow tools like Alteryx™ provide a drag-and-drop interface for designing transformation logic, they lack seamless integrations for automated migration to modern code-centric environments like DBT, necessitating manual conversion of workflows into structured DBT models. Other existing solutions rely on manually transcribing visual or textual descriptions into SQL code, which introduces inefficiencies and increases the likelihood of misinterpretation or errors. Furthermore, these approaches do not leverage multimodal inputs such as voice commands, images of whiteboard drawings, or freeform text notes to streamline the process. The absence of a unified, intelligent system that can process and translate diverse input formats into production-ready DBT models limits automation, increases development time, and creates barriers for non-technical users who seek to define and manage data transformations efficiently.

While some systems offer partial solutions, such as voice-to-code assistants that convert spoken instructions into SQL or scripting languages, these solutions are often generic and not specifically designed for DBT-based data transformation workflows. As a result, they lack the ability to interpret complex, structured transformations and dependencies inherent to DBT models. Moreover, existing tools fail to support a truly multimodal approach that integrates various input formats including text descriptions, visual diagrams, and voice commands into a cohesive system for generating production-ready DBT code. Without native support for DBT's modular structure, dependency management, and testing framework, these solutions leave significant gaps in user flexibility, requiring manual intervention to refine and optimize the generated code.

Therefore, in order to address the aforementioned challenges, there is a need for a method and system that can automatically create a DBT pipeline code by allowing users to provide an input of diverse formats.

### SUMMARY

The present disclosure relates to a method and system for automated generation of data pipeline code. Multi-modal input data comprising either a visual data, audio data, and textual data defining desired data transformations is received by the system. A hierarchical framework is then instantiated, which comprises multiple specialized artificial intelligence (AI) agents. The specialized AI agents can be a planner agent, an assembler agent, a validator agent, a code generator agent, a reflection agent, and a state agent.

The planner agent incorporated with a large language model (LLM) and computer vision capabilities, processes the multi-modal input data to extract structural elements defining a pipeline architecture. The assembler agent generates a pipeline configuration by incorporating database schema information into the extracted structural elements. The validator agent validates the pipeline configuration against predefined technical requirements through a user interface. The code generator agent generates an executable Data Build Tool (DBT) code implementing the validated pipeline configuration.

The reflection agent enhances the reliability of the generated DBT code by executing it within an isolated computing environment before deployment, which allows for runtime validation and early detection of execution errors. The reflection agent transmits the error data to the code generator agent which analyzes the errors, identify root causes, and initiate iterative modifications to the pipeline configuration or DBT code to resolve the detected issues.

The state agent accesses each of the plurality of specialized AI agents of the hierarchical framework to obtain agent state data and store the agent state. The state agent then transmit the stored agent state data between the plurality of specialized artificial intelligence agents to facilitate sequential processing of the data pipeline code.

### BRIEF DESCRIPTION OF THE FIGURES

FIG. 1 is a diagram that illustrates an exemplary environment within which various embodiments of the present disclosure may function.

FIG. 2 is a diagram that illustrates a system for automated generation of data pipeline code, in accordance with an embodiment of the present disclosure.

FIG. 3 is a diagram that illustrates the system with the hierarchical framework for automatically generating data pipeline code, in accordance with an exemplary embodiment of the disclosure.

FIG. 4 is a diagram that illustrates a flowchart for a method for automated generation of data pipeline code, in accordance with an embodiment of the present disclosure.

### DETAILED DESCRIPTION

Pursuant to various embodiments, the present disclosure relates to a method and system for automated generation of data pipeline code. Multi-modal input data comprising either a visual data, audio data, and textual data defining desired data transformations is received by the system. A hierarchical framework is then instantiated, which comprises multiple specialized AI agents. The specialized AI agents can be a planner agent, an assembler agent, a validator agent, a code generator agent, a reflection agent, and a state agent. The planner agent incorporated with an LLM and computer vision capabilities, processes the multi-modal input data to extract structural elements defining a pipeline architecture. The assembler agent generates a pipeline configuration by incorporating database schema information into the extracted structural elements. The validator agent validates the pipeline configuration against predefined technical requirements through a user interface. Finally, the code generator agent generates an executable DBT code implementing the validated pipeline configuration.

The reflection agent enhances the reliability of the generated DBT code by executing it within an isolated computing environment before deployment, which allows for runtime validation and early detection of execution errors. The reflection agent transmits the error data to the code generator agent which analyzes the errors, identify root causes, and initiate iterative modifications to the pipeline configuration or DBT code to resolve the detected issues.

The state agent accesses each of the plurality of specialized AI agents of the hierarchical framework to obtain agent state data and store the agent state. The state agent then transmit the stored agent state data between the plurality of specialized artificial intelligence agents to facilitate sequential processing of the data pipeline code.

In one or more embodiments, the data pipeline code refers to a structured set of instructions that define the ETL or ELT processes for managing data workflows within a modern data architecture. The code is written in SQL and leverages frameworks like DBT to modularize, optimize, and maintain transformations efficiently within a data warehouse. The data pipeline code encompasses various components, including staging models for raw data standardization, intermediate models for applying business logic, and final models for analytics-ready datasets. Additionally, the code integrates dependency management, automated testing, and documentation for data integrity and reproducibility.

In one or more embodiments, AI agents refer to intelligent software entities designed to autonomously or semi-autonomously perform tasks by perceiving inputs, analyzing data, making decisions, and executing actions within a given environment. The AI agents leverage machine learning, natural language processing, and rule-based algorithms to interpret multimodal inputs such as text, voice, or visual representations and generate structured outputs accordingly.

In one or more embodiments, the LLM refers to an advanced AI model trained on vast amounts of text data to understand, generate, and manipulate human language. LLMs leverage deep learning architectures, such as transformer-based neural networks, to process and generate contextually relevant text, making them highly effective in tasks like natural language understanding, text generation, and code synthesis.

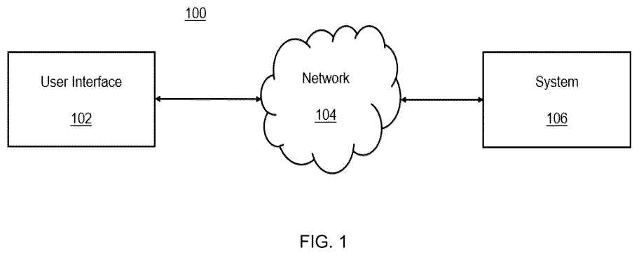

FIG. 1 is a diagram that illustrates an exemplary environment 100 within which various embodiments of the present disclosure may function. Referring to FIG. 1, the environment 100 comprises a user interface 102, a network 104, and a system 106.

The user interface 102 is configured to receive multi-modal input data from a user. The multi-modal input data can be at least one of visual data, audio data, and textual data. For instance, visual data can include images of handwritten notes, whiteboard sketches, or flow diagrams, audio data can include voice commands or spoken transformation requirements, and textual data can include structured or unstructured descriptions of data transformations.

In one or more embodiments, desired data transformations of the multi-modal input data refer to the specific operations and modifications that need to be applied to raw data to structure, refine, and prepare it for analytical or operational use. The transformations are extracted from textual descriptions, interpreted from visual pipeline diagrams, or transcribed from spoken instructions using natural language processing, visual understanding, and speech recognition models.

In one or more embodiments, the user can be a data engineer, data analyst, data scientist, business analyst, or any other individual responsible for defining, managing, or analyzing data transformations within an organization. The user may have varying levels of technical expertise, ranging from SQL-proficient engineers who build and optimize DBT models to non-technical business users who provide transformation requirements through natural language descriptions, voice commands, or visual representations.

In one or more embodiments, the user interface 102 can be part of a device that is located on-premise within an organization's infrastructure or at a remote location, such as a cloud-based platform or an edge computing device. The interface may be integrated into various computing environments, including desktop applications, web-based portals, or mobile applications, enabling users to interact with the system regardless of their physical location.

In one or more embodiments, the received multi-modal data defines desired data transformations by capturing user-specified requirements in various formats, including textual descriptions, voice commands, and visual representations such as diagrams or flowcharts. The system 106 processes this multi-modal input to extract transformation logic, identify dependencies, and generate structured DBT code that aligns with the specified data processing needs.

The network 104 refers to a communication infrastructure that facilitates data exchange between various components of the system, enabling seamless interaction between the user interface, processing modules, storage systems, and external data sources. The network 104 can include wired or wireless connections, such as local area networks (LAN), wide area networks (WAN), the Internet, or cloud-based networks. In one or more embodiments, the network 104 enables the transmission of multi-modal input data from the user interface 102 to the system 106, allowing real-time interpretation and conversion of transformation requirements into DBT code.

In some non-limiting embodiments, the cloud-based networks can be private, public, or hybrid, depending on the deployment requirements and security considerations of the organization. A private cloud network offers dedicated infrastructure and enhanced control over data security, making it suitable for enterprises with strict regulatory compliance needs. A public cloud network, on the other hand, leverages third-party cloud providers to offer scalable and cost-effective computing resources, enabling broader accessibility and ease of deployment. A hybrid cloud network combines elements of both private and public clouds, allowing organizations to balance security, performance, and scalability by selectively storing sensitive data on private infrastructure while utilizing public cloud resources for processing and computational tasks.

The system 106 is a multi-modal, multi-agentic framework configured to automatically generate data pipeline code in response to an input provided by the user. The system 106 leverages advanced visual, speech, and text understanding techniques to interpret multi-modal inputs, including handwritten notes, whiteboard diagrams, structured and unstructured text, and voice commands. By employing machine learning models, natural language processing, and computer vision, the system 106 extracts structural and relational data from these diverse input formats, identifies transformation logic, and maps it to pipeline components.

In one or more embodiments, the multi-agentic framework of the system 106 is powered by LLMs, where specialized agents collaborate to analyze user-provided transformation requirements, plan pipeline structures, assemble pipeline components, validate logic, and generate DBT code. Each agent within the multi-agentic framework is responsible for distinct tasks, such as extracting intent from multi-modal inputs, resolving ambiguities, optimizing query performance, and enabling compliance with best practices. The multi-agentic framework integrates Human-in-the-Loop (HIL) mechanisms, allowing users to review, refine, and approve generated pipelines, to align with both technical constraints and business objectives.

The HIL mechanism refers to an interactive feedback and validation system that enables human oversight and intervention at critical stages of the automated data pipeline generation process. The HIL mechanism allows users, such as data engineers or business analysts, to review, refine, and approve the transformation logic, pipeline structure, and generated DBT code before deployment. This mechanism enables that the automated outputs align with both technical specifications and business requirements by facilitating iterative feedback loops. Users can modify transformation rules, adjust schema mappings, validate dependencies, and correct potential errors through the user interface.

In one or more embodiments, the HIL mechanism is embedded at multiple critical stages within the disclosed system for accuracy, alignment with user expectations, and compliance with predefined transformation requirements. The HIL mechanism serves as an interactive feedback loop, allowing users to intervene, provide corrections, and refine the generated pipeline at various checkpoints.

At the planning stage, the HIL mechanism enables the user to review and approve the high-level pipeline plan generated by the planner agent so that the system correctly interprets the user's intent from the multi-modal input and accurately translates it into transformation operations. The user can suggest modifications, refine transformation logic, or adjust schema mappings before the pipeline progresses to the next stage.

At the assembly stage, the HIL mechanism facilitates user validation of the assembled pipeline configuration. The assembler agent configures pipeline nodes by incorporating database schema information, mapping transformation operations, and linking dependencies. The user can inspect the generated pipeline structure, verify schema relationships, and confirm that all required transformations are correctly incorporated.

At the validation stage, the HIL mechanism allows the user to intervene if critical errors, schema mismatches, or edge cases are flagged by the validator agent. The validator agent performs an iterative self-assessment to identify inconsistencies, inefficiencies, and compliance deviations. If anomalies are detected, the user can provide corrective inputs, adjust transformation rules, or approve exceptions, so the final pipeline adheres to business and technical requirements.

In one or more embodiments, the system 106 maps the database schema, configures pipeline nodes, and self-refines outputs, significantly reducing manual effort and improving precision. By leveraging LLM-powered AI agents, the system 106 automatically analyzes the structure of the target database, including table relationships, column types, and indexing strategies, so that the generated DBT code aligns with the existing data architecture.

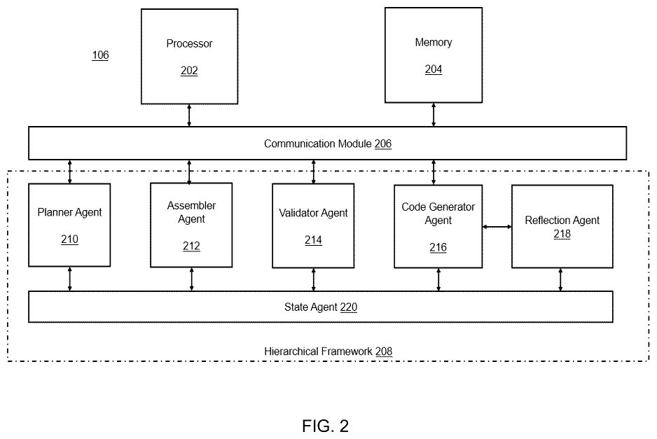

FIG. 2 is a diagram that illustrates the system 106 for automated generation of data pipeline code, in accordance with an embodiment of the present disclosure. Referring to FIG. 2, the system 106 comprises a memory 202, a processor 204, a communication module 206, a hierarchical framework 208 with a planner agent 210, an assembler agent 212, a validator agent 214, a code generator agent 216, a reflection agent 218, and a state agent (220).

The memory 202 may comprise suitable logic, code, and/or interfaces that may be configured to store instructions (for example, computer-readable program code) that can implement various aspects of the present disclosure.

The processor 204 may comprise suitable logic, code, and/or interfaces that may be configured to execute the instructions stored in the memory 202 to implement various functionalities of the system 106 in accordance with various aspects of the present disclosure. The communication module 206 is configured to facilitate seamless interaction between the processor 204 and various modules within the system 106.

Upon receiving the multi-modal input data from the user, the system 106 instantiates the hierarchical framework 208 which comprises a plurality of specialized AI agents. The plurality of specialized AI agents include the planner agent 210, the assembler agent 212, the validator agent 214, the code generator agent 216 and the reflection agent 218.

In one or more embodiments, the hierarchical framework 208 of the system 106 may dynamically coordinate the interactions between the specialized AI agents for accurate pipeline generation process. The hierarchical framework 208 leverages adaptive task allocation, where each AI agent processes specific aspects of the transformation requirements, collaborates with other agents, and refines intermediate outputs before finalizing the DBT code.

In one or more embodiments, the hierarchical framework 208 refers to a multi-agent framework designed to orchestrate the automated generation of data pipeline code by leveraging specialized AI agents. The hierarchical framework operates in a structured manner, where each AI agent is assigned a specific role in analyzing, planning, assembling, validating, and generating the DBT code. The hierarchical nature of the framework allows the agents collaborate efficiently, following a sequential and interdependent workflow. For instance, the planner agent first interprets multi-modal input data to extract transformation requirements, the assembler agent structures these transformations into a coherent pipeline, the validator agent enables correctness and compliance with predefined constraints, and the code generator agent translates the validated logic into executable DBT code.

The planner agent 210 may comprise suitable logic, code, and/or interfaces that may be configured to process the multi-modal input data to extract structural elements defining a pipeline structure. The structural elements can be such as, but not limited to, data sources, transformation, dependencies, schema mapping, pipeline nodes, execution logic, and output destinations.

In one or more embodiments, the planner agent 210 is incorporated with an LLM and computer vision capabilities to process the multi-modal input. The LLM enables the planner agent 210 to understand, interpret, and extract transformation requirements from textual descriptions, verbal instructions, and structured or unstructured documentation. Additionally, the computer vision capabilities allow the planner agent 210 to analyze visual inputs, such as whiteboard drawings, flowcharts, or screenshots of existing data models, to identify structural elements defining the data pipeline.

In one or more embodiments, processing the multi-modal input data by the planner agent 210 includes analyzing visual, audio, and textual inputs using specialized AI models. The visual data is processed using a visual understanding model that interprets pipeline diagrams, entity-relationship (ER) models, and structured flowcharts to identify key pipeline components, such as data sources, transformation steps, and dependencies. The audio data is converted into text using a speech recognition model, which accurately transcribes verbal instructions and extracts relevant transformation logic. Once the input is in textual form, the planner agent 210 utilizes an NLP model to extract transformation instructions, identify key entities, and map them to DBT components.

In one or more embodiments, the planner agent 210 is configured to identify transformation operations from the multi-modal input data, generate a high-level pipeline plan based on the identified transformation operations, and receive user approval via the user interface 102 before pipeline creation. Specifically, the planner agent 210 analyzes the extracted transformation instructions to detect operations such as filtering, aggregations, joins, data type conversions, and schema mappings. Based on this analysis, it constructs a structured pipeline plan that outlines the sequence of transformations, dependencies, and data flow logic. This high-level plan is then presented to the user through the user interface 102, enabling review, modifications, or refinements before proceeding with automated pipeline assembly.

In one or more embodiments, the planner agent 210 is an AI agent that is trained to interpret multi-modal input data, extract transformation requirements, and generate a structured high-level pipeline plan. The planner agent 210 is equipped with advanced machine learning models, including natural language processing (NLP), computer vision, and speech recognition, enabling it to process text-based specifications, analyze visual representations such as pipeline diagrams, and transcribe spoken instructions into actionable transformation logic. By leveraging LLMs and domain-specific training, the planner agent 210 can identify transformation operations, recognize dependencies between data sources, and structure the pipeline flow accordingly.

The assembler agent 212 may comprise suitable logic, code, and/or interfaces that may be configured to generate a pipeline configuration by incorporating database schema information into the extracted structural elements. The assembler agent 212 processes the high-level pipeline plan generated by the planner agent 210 and translates it into a structured pipeline representation by mapping data sources, defining transformation nodes, and establishing dependencies between different stages of the pipeline.

In one or more embodiments, the assembler agent 212 is configured to dynamically query the database schema information and utilize the retrieved metadata to configure pipeline nodes in a structured manner. The assembler agent 212 begins by extracting schema details such as table structures, column names, data types, primary and foreign key relationships, constraints, and indexing metadata from the target database. The database schema information provides a foundational understanding of how data is structured within the source and destination systems.

Once the schema details are retrieved, the assembler agent 212 automatically configures pipeline nodes by aligning the database schema with the transformation logic derived from the multi-modal input. Each pipeline node represents a specific transformation operation (e.g., data filtering, aggregation, joins, normalization, or feature engineering), and the assembler agent 212 organizes these nodes in a logical sequence based on dependencies between different transformations.

After configuring the pipeline nodes, the assembler agent 212 maps the transformation operations between these nodes, so that data flows correctly through the pipeline. The mapping process involves establishing input-output relationships between transformations, defining data lineage, and handling potential schema mismatches by applying necessary adjustments such as data type conversions, renaming, or structural modifications. Additionally, the assembler agent 212 optimizes node connections by leveraging best practices for DBT model structuring, so that the resulting data pipeline is efficient, scalable, and aligned with business requirements.

In one or more embodiments, the assembler agent 212 is an AI agent that is trained to interpret, structure, and optimize data transformation workflows based on queried database schema information. The assembler agent 212 is designed to process the high-level pipeline plan generated by the planner agent 210 and translate it into a structured pipeline configuration that aligns with the underlying database schema and transformation logic.

To achieve this, the assembler agent 212 is trained on a diverse set of database schemas, data modeling patterns, transformation operations, and best practices in data pipeline development. This training enables the assembler agent 212 to intelligently analyze schema metadata, recognize relationships between tables, infer dependencies between transformations, and optimize pipeline structure for efficient execution.

Additionally, the assembler agent 212 is trained to handle schema evolution, inconsistencies, and missing metadata by applying techniques such as schema inference, anomaly detection, and adaptive transformation mapping. It can dynamically adjust node configurations, establish input-output dependencies, and enable data lineage consistency throughout the pipeline.

The validator agent 214 may comprise suitable logic, code, and/or interfaces that may be configured to validate the pipeline configuration against predefined technical requirements, through a user interface.

In one or more embodiments, the validator agent 214 is configured to perform iterative self-assessment of the pipeline configuration to identify inconsistencies and inefficiencies before the pipeline is finalized. The validator agent 214 systematically analyzes the structural, logical, and performance aspects of the pipeline to ensure that it aligns with the predefined technical requirements and best practices for DBT-based transformations.

To achieve this, the validator agent 214 conducts multi-level validation. At the structural level, it verifies that the pipeline nodes are correctly configured, transformation dependencies are properly mapped, and the execution flow maintains logical integrity. At the schema level, it checks for data type mismatches, missing fields, and compatibility issues between input and output datasets. At the optimization level, it assesses whether the query execution plan is efficient, flagging redundant computations, unnecessary data movements, or potential bottlenecks that could degrade performance.

The validator agent 214 employs automated rule-based checks, heuristic-driven anomaly detection, and machine learning-based performance evaluation to continuously refine the pipeline's structure. Through iterative validation cycles, the validator agent 214 dynamically identifies inconsistencies, suggests corrective actions, and refines transformation logic to enable compliance with both technical constraints and business logic expectations.

Once inconsistencies or inefficiencies are detected, the validator agent 214 compares the pipeline configuration against predefined technical requirements, such as data governance policies, security protocols, and performance benchmarks. If discrepancies are found, the validator agent 214 either automatically applies corrective measures or prompts the user via the user interface 102 for manual intervention. This iterative self-assessment mechanism reduces the risk of errors, enhances the reliability of the generated DBT code, and accelerates the validation process, streamlining the deployment of high-quality data pipelines.

In one or more embodiments, the user interface 102 facilitates human validation at multiple stages of the pipeline generation process, including the pipeline planning stage, pipeline assembly stage, and code validation stage. During the pipeline planning stage, the user interface 102 enables the user to review and refine the high-level pipeline structure, so that the extracted transformation requirements accurately reflect business needs. The user can interact with visual representations, text summaries, or structured forms to validate and modify the proposed pipeline design before proceeding to assembly.

At the pipeline assembly stage, the user interface provides an interactive environment for users to verify schema mappings, transformation dependencies, and data flow connections between pipeline nodes. The user can approve or adjust configurations dynamically, so that the assembled pipeline adheres to database schema constraints and operational requirements.

During the code validation stage, the user interface 102 allows users to inspect the generated DBT code, review validation results, and address flagged inconsistencies. The user interface 102 may present error messages, optimization suggestions, and compliance reports based on the validation performed by the validator agent 214. The user can either approve the validated pipeline for deployment or provide feedback for further refinements, to align with both technical and business requirements.

In one or more embodiments, the validator agent 214 is an AI agent that is trained using a combination of machine learning models, rule-based validation mechanisms, and heuristic techniques to ensure the generated pipeline configuration aligns with predefined technical and business requirements. The validator agent 214 leverages historical pipeline configurations, best practices, and optimization strategies to perform automated checks and iterative self-assessments on the pipeline structure.

The validator agent 214 is trained to analyze schema constraints, transformation dependencies, performance bottlenecks, and logical inconsistencies within the pipeline configuration. It cross-references the pipeline against industry standards, organizational policies, and DBT-specific constraints to ensure compliance. Additionally, the validator agent 214 can simulate execution scenarios, predicting potential failures, inefficiencies, or data integrity issues before the pipeline is deployed.

In one or more embodiments, the code generator agent 216 may comprise suitable logic, code, and/or interface that may be configured to generate an executable DBT code implementing the validated pipeline configuration.

In one or more embodiments, the code generator agent 216 is configured to generate SQL transformations in accordance with DBT specifications, so that the generated transformations are optimized for scalability, modularity, and maintainability. The code generator agent 216 analyzes the validated pipeline configuration, extracts the required transformation logic, and dynamically constructs SQL queries that adhere to DBT best practices, including incremental processing, dependency tracking, and performance optimization.

The code generator agent 216 enables that the generated SQL transformations are parameterized and reusable, enabling efficient data processing across large-scale datasets. It applies scalability protocols, such as adaptive partitioning, query optimization techniques, and parallel execution strategies, to enhance execution efficiency. The generated SQL transformations are then structured as DBT-compatible model configurations, incorporating DBT metadata, model dependencies, and appropriate configurations for materialization strategies (e.g., views, tables, or incremental models).

In one or more embodiments, the code generator agent 216 is an AI agent that is trained on large-scale SQL transformation patterns, DBT specifications, and optimization techniques to generate executable DBT code. The code generator agent 216 is trained using supervised learning, reinforcement learning, and few-shot learning approaches to understand how to translate validated pipeline configurations into efficient, scalable DBT models.

The training data for the code generator agent 216 includes historical DBT transformation scripts, annotated SQL queries, best practices for data transformation, and performance benchmarks across different database environments. The code generator agent 216 learns to incorporate DBT-specific features, such as for example, macro-based abstractions, incremental processing strategies, so that the generated code is both modular and reusable.

In one or more embodiments, the reflection agent 218 is an AI agent designed to enhance the reliability of the generated DBT code by executing it within an isolated computing environment before deployment. The reflection agent 218 simulates real-world execution conditions by running the executable DBT code in a sandboxed environment that mirrors the target data processing system. This allows for runtime validation and early detection of execution errors, such as SQL syntax errors, missing dependencies, schema mismatches, or performance bottlenecks.

Upon detecting errors or inefficiencies, the reflection agent 218 captures detailed error logs, execution traces, and performance metrics. The reflection agent 218 then transmits this error data and diagnostics to the code generator agent 216. The code generator agent 216 in collaboration with the other specialized AI agents of the hierarchical framework 208 analyzes the errors, identify root causes, and initiate iterative modifications to the pipeline configuration or DBT code to resolve the detected issues.

In one or more embodiments, the reflection agent 218 is an AI agent that is trained using reinforcement learning, supervised learning, and historical execution data to detect, analyze, and resolve runtime errors in DBT-generated code. The reflection agent 218 is trained on a dataset comprising successful and failed DBT executions, SQL execution logs, error patterns, schema mismatches, and performance optimization strategies.

The reflection agent 218 learns to simulate execution environments, run sandboxed executions of DBT code, and identify runtime anomalies, such as SQL syntax errors, dependency failures, and inefficient query execution plans. Using reinforcement learning, the reflection agent 218 continuously refines its ability to diagnose issues and recommend corrective actions by evaluating feedback from historical debugging sessions.

The state agent 220 may comprise suitable logic, code, and/or interfaces that may be configured to access each of the plurality of specialized AI agents of the hierarchical framework 208.

In one or more embodiments, the state agent 220 obtains agent state data from each of the plurality of specialized artificial intelligence agents within the hierarchical framework (208). The agent state data comprises user inputs provided to the system (106), which represent the user's requests or instructions to the artificial intelligence agents; agent recommendations, which denote the processing decisions or actions proposed by the specialized artificial intelligence agents based on the user input or internal logic; and human validation feedback, which comprises any user-provided responses, corrections, or input received during interactions with the agents.

The real-time data gathered by the state agent 220 serves as a dynamic record of the ongoing state of each agent, enabling the system (106) to track the evolution of the interaction or decision-making process. This information is critical for maintaining the coherence and continuity of the operations between agents, particularly when tasks are handed over or when an agent must make decisions based on previously gathered insights.

For example, if the planner agent 210 proposes a course of action based on a user's input, the state agent 220 stores this information and makes it accessible to subsequent agents, who may rely on the prior recommendations and validation feedback to refine or execute their portion of the process.

In one or more embodiments, the state agent 220 is configured to facilitate the handover of the obtained state information between the plurality of specialized AI agents within the system 106, enabling sequential processing of the data pipeline code.

In one or more embodiments, when a task or decision-making responsibility is transitioned from one agent to another, the state agent 220 ensures that all pertinent state information such as prior user inputs, agent suggestions, and human feedback is passed along in real time. This handover is not merely the transfer of raw data but involves enables that the context in which the data was generated is also preserved. For instance, if an earlier agent, such as the planner agent 210, has formulated a specific action plan based on a user's query and human feedback, the state agent 220 confirms that this information is made accessible to subsequent agents, who may need to build on the plan, conduct additional analysis, or take further actions.

In one or more embodiments, the state agent 220 ensures that the specialized agents do not operate in isolation. Instead, each agent, while focusing on its area of expertise, is provided with all the necessary contextual history from previous steps, allowing for intelligent decision-making in subsequent stages of the process. The handover mechanism allows agents to synchronize their actions and maintain continuity in the workflow.

In one or more embodiments, the stage agent 220 is an AI agent configured to manage and track the operational states of the plurality of specialized AI agents within the hierarchical framework 208. The state agent 220 may be trained using supervised learning and reinforcement learning techniques on a dataset comprising agent interactions, pipeline execution logs, error recovery sequences, and workflow dependencies to facilitate sequential processing of the data pipeline code.

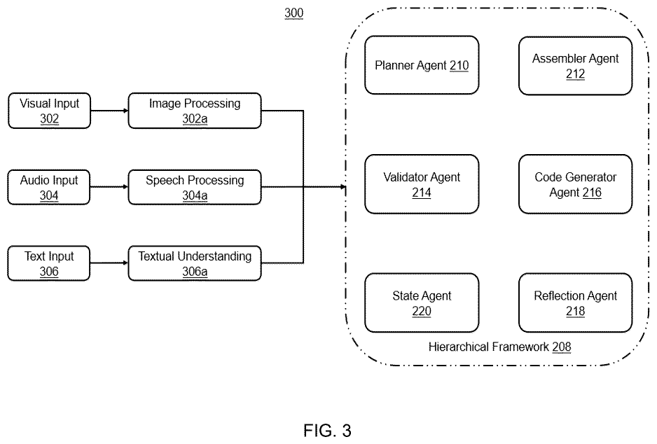

FIG. 3 is a diagram that illustrates the system 106 with the hierarchical framework for automatically generating data pipeline code, in accordance with an exemplary embodiment of the disclosure.

Referring to FIG. 3, the system 106 processes multi-modal inputs a visual (image) input 302, an audio input 304, and a textual input 306 to generate an executable DBT code for a data transformation pipeline. The example illustrates the end-to-end operation of the disclosure, leveraging the planner agent 210, the assembler agent 212, the validator agent 214, the code generator agent 216, and the reflection agent 218.

A data engineer needs to create a DBT pipeline for transforming customer sales data stored in a cloud data warehouse. Instead of manually coding the pipeline, the engineer interacts with the user interface 102 and provides inputs in three different modalities:
Visual Input 302: The user uploads a hand-drawn pipeline diagram showing data sources (customer orders table, product table), transformation steps (data cleaning, aggregation, and enrichment), and the final output table.
Audio Input 304: The user provides a verbal description, saying, “We need to extract customer purchase records, join them with product data, clean up any missing values, aggregate total sales per region, and output the final dataset for analytics.”
Textual Input 306: The user types,
“Transform customer_orders by joining product_catalog, filter out NULL values, calculate total_revenue per region, and store the output as sales_summary.”

Once the inputs are received, the planner agent 210 processes them:
Image Processing 302a: A visual understanding model extracts entities (tables, transformations, output datasets) and relationships from the pipeline diagram.
Speech Processing 304a: A speech recognition model converts the audio description into text, which is further processed using natural language processing (NLP).
Text understanding 306a: the planner agent 210 parses the textual input to extract transformation instructions.

Using this extracted information, the planner agent 210 generates a high-level pipeline plan, mapping the required transformations, dependencies, and data flow. The system 106 then requests user approval via the user interface 102 before proceeding to the next stage.

Upon approval, the assembler agent 212 dynamically queries the database schema to validate the existence of customer_orders and product_catalog tables. The agent then:

Configures pipeline nodes corresponding to:
Data Extraction: Reading customer_orders and product_catalog
Data Transformation: Filtering NULL values, performing JOIN
Aggregation: Summing total_revenue per region
Final Output: Writing to sales_summary

Maps transformation operations between the pipeline nodes.

Structures a logical execution flow for efficient processing.

Before generating the DBT code, the validator agent 214 verifies that the pipeline configuration aligns with technical requirements:
Confirms schema consistency (column names, data types).
Checks for missing dependencies (confirming all required tables exist).
Identifies inefficiencies (such as unnecessary joins or redundant computations).
Compares the pipeline logic against predefined data governance rules.

The validator agent 214 flags potential issues and requests human validation via the user interface 102, allowing the engineer to review and approve or modify the pipeline configuration.

After validation, the code generator agent 216 translates the structured pipeline into DBT-compatible SQL transformations:
Creates DBT model configurations
Generates SQL transformations

Before final deployment, the reflection agent 218 executes the DBT model in an isolated environment to detect potential errors. If any runtime errors occur (e.g., missing table references, syntax issues, slow query execution), the reflection agent 218:
Logs the error data.
Analyzes root causes (e.g., incorrect column mapping).
Triggers re-evaluation by transmitting issues back to the code generator agent 216 for refinement.

The pipeline undergoes iterative debugging until the DBT code executes successfully.

The state agent 220 captures real-time information about the entire pipeline creation process, maintaining a detailed record of key events such as user inputs, agent actions, and human feedback. This information includes:
User Prompts: The inputs provided by the data engineer in the form of visual, audio, and textual instructions.
Agent Suggestions: Suggestions made by specialized agents at each stage (e.g., planner agent's proposed transformations, assembler agent's pipeline structure).
Human feedback: any changes or approvals from the user after reviewing agent suggestions or validation checks.

As the system 106 progresses through the stages, the state agent 220 constantly tracks the changes and updates. For example, when the planner agent 210 processes the three different modalities of input (image, audio, and text) and generates the high-level pipeline plan, the state agent 220 records the specifics of the plan and makes it accessible to subsequent agents.

This ensures that when the assembler agent 212 begins to configure the pipeline nodes, it has immediate access to the user's original input, the planner agent's 210 proposed plan, and any feedback already given by the user. The state agent 220, in effect, acts as the memory of the system 106, continuously storing and updating the context.

When the validator agent 214 verifies the pipeline configuration, it flags potential issues. The state agent 220 ensures that all this information, including the flagged issues, is passed to the reflection agent 218, which will test the DBT model in an isolated environment. If errors are identified during this reflection phase (e.g., missing table references or slow query execution), the state agent 220 stores the error data and sends it back to the code generator agent 216 for refinement.

For example, if the reflection agent 218 detects an error related to an incorrect JOIN operation, the state agent 220 not only logs this error but also links it with the previous stages, such as the assembler agent's 212 mapping of transformation operations and the planner agent's 210 initial pipeline plan.

Furthermore, when the system 106 receives human feedback through the user interface 102 (e.g., approving or modifying the pipeline configuration or code generation steps), the state agent 220 facilitates that this feedback is stored in real time and is accessible by all agents involved in the process. If human input leads to changes in the DBT code or pipeline structure, the state agent 220 facilitates that these adjustments are seamlessly integrated into the ongoing workflow, maintaining coherence across all agents.

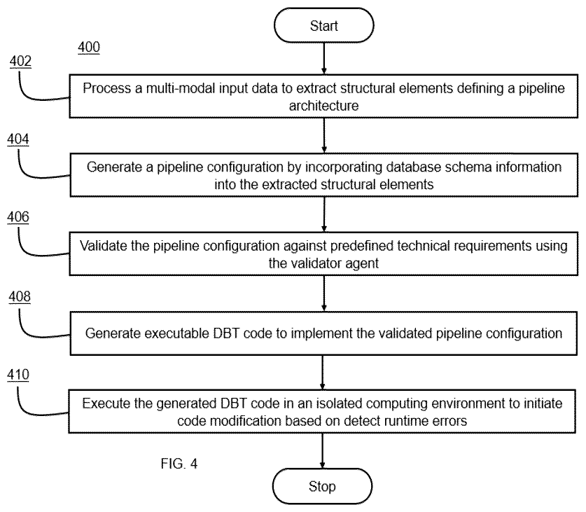

FIG. 4 is a diagram that illustrates a flowchart 400 for a method for automated generation of data pipeline code, in accordance with an embodiment of the present disclosure.

Upon receiving the multi-modal input data from the user, the system 106 instantiates the hierarchical framework 208 which comprises a plurality of specialized AI agents. The plurality of specialized AI agents includes the planner agent 210, the assembler agent 212, the validator agent 214, the code generator agent 216 and the reflector agent 218.

At 402, the planner agent 210, by utilizing an LLM, processes the multi-modal input data to extract structural elements defining a pipeline architecture. The structural elements can be such as, but not limited to, data sources, transformation, dependencies, schema mapping, pipeline nodes, execution logic, and output destinations.

In one or more embodiments, the planner agent 210 is incorporated with an LLM and computer vision capabilities to process the multi-modal input. The LLM enables the planner agent 210 to understand, interpret, and extract transformation requirements from textual descriptions, verbal instructions, and structured or unstructured documentation. Additionally, the computer vision capabilities allow the planner agent 210 to analyze visual inputs, such as whiteboard drawings, flowcharts, or screenshots of existing data models, to identify structural elements defining the data pipeline.

In one or more embodiments, processing the multi-modal input data by the planner agent 210 includes analyzing visual, audio, and textual inputs using specialized AI models. The visual data is processed using a visual understanding model that interprets pipeline diagrams, entity-relationship (ER) models, and structured flowcharts to identify key pipeline components, such as data sources, transformation steps, and dependencies. The audio data is converted into text using a speech recognition model, which accurately transcribes verbal instructions and extracts relevant transformation logic. Once the input is in textual form, the planner agent 210 utilizes an NLP model to extract transformation instructions, identify key entities, and map them to DBT components.

In one or more embodiments, the planner agent 210 is configured to identify transformation operations from the multi-modal input data, generate a high-level pipeline plan based on the identified transformation operations, and receive user approval via the user interface 102 before pipeline creation. Specifically, the planner agent 210 analyzes the extracted transformation instructions to detect operations such as filtering, aggregations, joins, data type conversions, and schema mappings. Based on this analysis, it constructs a structured pipeline plan that outlines the sequence of transformations, dependencies, and data flow logic. This high-level plan is then presented to the user through the user interface 102, enabling review, modifications, or refinements before proceeding with automated pipeline assembly.

At 404, the assembler agent 212 generates a pipeline configuration by incorporating database schema information into the extracted structural elements. The assembler agent 212 processes the high-level pipeline plan generated by the planner agent 210 and translates it into a structured pipeline representation by mapping data sources, defining transformation nodes, and establishing dependencies between different stages of the pipeline.

In one or more embodiments, the assembler agent 212 is configured to dynamically query the database schema information and utilize the retrieved metadata to configure pipeline nodes in a structured manner. The assembler agent 212 begins by extracting schema details such as table structures, column names, data types, primary and foreign key relationships, constraints, and indexing metadata from the target database. The schema information provides a foundational understanding of how data is structured within the source and destination systems.

Once the schema details are retrieved, the assembler agent 212 automatically configures pipeline nodes by aligning the database schema with the transformation logic derived from the multi-modal input. Each pipeline node represents a specific transformation operation (e.g., data filtering, aggregation, joins, normalization, or feature engineering), and the assembler agent 212 organizes these nodes in a logical sequence based on dependencies between different transformations.

After configuring the pipeline nodes, the assembler agent 212 maps the transformation operations between these nodes, so that data flows correctly through the pipeline. The mapping process involves establishing input-output relationships between transformations, defining data lineage, and handling potential schema mismatches by applying necessary adjustments such as data type conversions, renaming, or structural modifications. Additionally, the assembler agent 212 optimizes node connections by leveraging best practices for DBT model structuring, so that the resulting data pipeline is efficient, scalable, and aligned with business requirements.

At 406, the pipeline configuration is validated against predefined technical requirements using the validator agent 214.

In one or more embodiments, the validator agent 214 is configured to perform iterative self-assessment of the pipeline configuration to identify inconsistencies and inefficiencies before the pipeline is finalized. The validator agent 214 systematically analyzes the structural, logical, and performance aspects of the pipeline to align with the predefined technical requirements and best practices for DBT-based transformations.

To achieve this, the validator agent 214 conducts multi-level validation. At the structural level, it verifies that the pipeline nodes are correctly configured, transformation dependencies are properly mapped, and the execution flow maintains logical integrity. At the schema level, it checks for data type mismatches, missing fields, and compatibility issues between input and output datasets. At the optimization level, it assesses whether the query execution plan is efficient, flagging redundant computations, unnecessary data movements, or potential bottlenecks that could degrade performance.

The validator agent 214 employs automated rule-based checks, heuristic-driven anomaly detection, and machine learning-based performance evaluation to continuously refine the pipeline's structure. Through iterative validation cycles, the validator agent 214 dynamically identifies inconsistencies, suggests corrective actions, and refines transformation logic to enable compliance with both technical constraints and business logic expectations.

Once inconsistencies or inefficiencies are detected, the validator agent 214 compares the pipeline configuration against predefined technical requirements, such as data governance policies, security protocols, and performance benchmarks. If discrepancies are found, the validator agent 214 either automatically applies corrective measures or prompts the user via the user interface 102 for manual intervention. This iterative self-assessment mechanism reduces the risk of errors, enhances the reliability of the generated DBT code, and accelerates the validation process, streamlining the deployment of high-quality data pipelines.

In one or more embodiments, the user interface 102 facilitates human validation at multiple stages of the pipeline generation process, including the pipeline planning stage, pipeline assembly stage, and code validation stage. During the pipeline planning stage, the user interface 102 enables the user to review and refine the high-level pipeline structure, so that the extracted transformation requirements accurately reflect business needs. The user can interact with visual representations, text summaries, or structured forms to validate and modify the proposed pipeline design before proceeding to assembly.

At the pipeline assembly stage, the user interface provides an interactive environment for users to verify schema mappings, transformation dependencies, and data flow connections between pipeline nodes. The user can approve or adjust configurations dynamically, so that the assembled pipeline adheres to database schema constraints and operational requirements.

During the code validation stage, the user interface 102 allows users to inspect the generated DBT code, review validation results, and address flagged inconsistencies. The user interface 102 may present error messages, optimization suggestions, and compliance reports based on the validation performed by the validator agent 214. The user can either approve the validated pipeline for deployment or provide feedback for further refinements, to align with both technical and business requirements.

At 408, executable DBT code is generated by the code generation agent 216 to implement the validated pipeline configuration.

In one or more embodiments, the code generator agent 216 is configured to generate SQL transformations in accordance with DBT specifications, so that the generated transformations are optimized for scalability, modularity, and maintainability. The code generator agent 216 analyzes the validated pipeline configuration, extracts the required transformation logic, and dynamically constructs SQL queries that adhere to DBT best practices, including incremental processing, dependency tracking, and performance optimization.

The code generator agent 216 ensures that the generated SQL transformations are parameterized and reusable, enabling efficient data processing across large-scale datasets. It applies scalability protocols, such as adaptive partitioning, query optimization techniques, and parallel execution strategies, to enhance execution efficiency. The generated SQL transformations are then structured as DBT-compatible model configurations, incorporating DBT metadata, model dependencies, and appropriate configurations for materialization strategies (e.g., views, tables, or incremental models).

At 410, the reflector agent 218 executes the executable DBT code in an isolated computing environment. Thereafter, upon detecting errors or inefficiencies, the reflection agent 218 captures detailed error logs, execution traces, and performance metrics. The reflection agent 218 then transmits this error data and diagnostics to the code generator agent 216. The code generator agent 216 in collaboration with the other specialized AI agents of the hierarchical framework 208 analyzes the errors, identify root causes, and initiate iterative modifications to the pipeline configuration or DBT code to resolve the detected issues.

In accordance with the method for automated generation of data pipeline code, the present disclosure further comprises a state agent 220 that is configured to access each of the plurality of specialized AI agents of the hierarchical framework 208.

In one or more embodiments, the state agent 220 obtains agent state data from each of the plurality of specialized artificial intelligence agents within the hierarchical framework (208). The agent state data comprises user inputs provided to the system (106), which represent the user's requests or instructions to the artificial intelligence agents; agent recommendations, which denote the processing decisions or actions proposed by the specialized artificial intelligence agents based on the user input or internal logic; and human validation feedback, which comprises any user-provided responses, corrections, or input received during interactions with the agents.

The real-time data gathered by the state agent 220 serves as a dynamic record of the ongoing state of each agent, enabling the system (106) to track the evolution of the interaction or decision-making process. This information is critical for maintaining the coherence and continuity of the operations between agents, particularly when tasks are handed over or when an agent must make decisions based on previously gathered insights.

In one or more embodiments, the state agent 220 is configured to facilitate the handover of the obtained state information between the plurality of specialized AI agents within the system 106, sequential processing of the data pipeline code.

In one or more embodiments, when a task or decision-making responsibility is transitioned from one agent to another, the state agent 220 ensures that all pertinent state information such as prior user inputs, agent suggestions, and human feedback is passed along in real time. This handover is not merely the transfer of raw data but involves enables that the context in which the data was generated is also preserved. For instance, if an earlier agent, such as the planner agent 210, has formulated a specific action plan based on a user's query and human feedback, the state agent 220 confirms that this information is made accessible to subsequent agents, who may need to build on the plan, conduct additional analysis, or take further actions.

The present disclosure is technically advantageous as it introduces a multi-agentic framework capable of seamlessly integrating multimodal inputs, including voice, image, and text, into a unified and intelligent data pipeline generation process. Unlike conventional approaches that rely on manual transcription or isolated processing of different input formats, the disclosed system leverages AI agents to interpret, analyze, and synthesize multimodal data in a structured manner. By doing so, the system significantly enhances the flexibility and accessibility of data pipeline creation, allowing users to interact with the system using their preferred mode of communication. This capability not only streamlines the workflow but also minimizes the dependency on highly technical expertise for translating abstract transformation requirements into production-ready DBT code. The integration of multimodal inputs enables a more natural and intuitive user experience, reducing cognitive load and enhancing efficiency in defining data transformation logic.

The present disclosure provides a significant advantage over traditional solutions by introducing an intelligent system capable of comprehending and extracting structural and relational data from diverse input formats, including images, text, and audio. Conventional approaches often require manual effort to interpret and convert transformation requirements into pipeline components, leading to inefficiencies, errors, and inconsistencies. In contrast, the disclosed system leverages AI-driven processing to systematically analyze multimodal inputs, identifying key transformation operations, dependencies, and relationships within the data. By extracting structural and relational information from these inputs, the system confirms that the generated pipeline components accurately reflect the intended transformations. This automated process significantly reduces the risk of misinterpretation and minimizes the effort required to manually map inputs to pipeline configurations. The system further translates the extracted insights into precise DBT transformation code, to align with industry best practices and optimize performance. By enabling direct and accurate conversion of abstract transformation requirements into executable code, the disclosed system enhances efficiency, improves accuracy, and accelerates the development of modern data pipelines.

The disclosed method and system offer a transformative approach to data pipeline creation by eliminating the need for multiple iterations of manual coding, logical structuring, and validation. Traditional methods require extensive back-and-forth between data engineers and business stakeholders to refine transformation logic, often leading to prolonged development cycles and an increased risk of human-induced errors. In contrast, the present disclosure leverages an AI-driven multi-agentic framework to automate key stages of pipeline generation, significantly reducing the cognitive load on users and minimizing manual intervention. By systematically processing multimodal inputs, intelligently assembling pipeline components, and enabling validation through automated checks and human-in-the-loop mechanisms, the system streamlines the entire pipeline development process. This results in a drastic reduction in turnaround time, enabling rapid deployment of accurate and optimized DBT transformation pipelines. Furthermore, by reducing reliance on manual coding and validation efforts, the system minimizes the likelihood of syntax errors, logical inconsistencies, and misconfigurations, ensuring high-quality, production-ready pipelines with minimal iterations.

The disclosed method and system provide a significant technical advancement by enabling non-technical users to generate DBT code effortlessly through intuitive multimodal inputs such as drawings, textual descriptions, or audio commands. Traditionally, data transformation pipeline creation has been a complex process requiring specialized knowledge of SQL, DBT configurations, and data modeling principles. Business users, who may have deep domain expertise but lack technical proficiency, often struggle to translate their transformation requirements into executable code.

Furthermore, the disclosed method and system offer a technically superior approach by embedding HIL checkpoints at multiple critical stages of the pipeline generation process. Unlike fully automated solutions that lack user oversight, this disclosure strategically integrates human validation at key decision points, such as planning, assembly, and validation. By doing so, it allows that the generated pipeline aligns with both technical specifications and business requirements while allowing users to refine or override AI-generated outputs when necessary. This collaborative approach enhances trust in the system, as users can review and confirm transformation logic, validate database mappings, and intervene in cases where critical errors or edge cases arise. Additionally, the adaptability introduced by HIL mechanisms allows the system to continuously learn from human feedback, improving the precision and contextual understanding of the generated DBT code over time.

Furthermore, the disclosed method and system provide a significant technical advancement over traditional systems by automating the mapping of database schemas, configuring pipeline nodes, and refining outputs without requiring extensive manual intervention. Unlike conventional approaches that rely on data engineers to manually interpret schema structures, define pipeline connections, and troubleshoot inconsistencies, the present disclosure intelligently analyzes the database schema and dynamically configures the necessary transformations. The system's ability to self-refine outputs through iterative validation and feedback loops confirms that the generated pipeline code adheres to best practices, optimizes performance, and minimizes errors. This automation not only accelerates the development of data transformation pipelines but also enhances precision, as AI-driven validation confirms that pipeline configurations align with the expected data structure and processing logic.

Furthermore, the disclosed method and system automates complex data transformation processes by intelligently interpreting multimodal inputs and translating them into executable pipeline configurations. Unlike traditional approaches that require extensive manual coding and iterative debugging, the system streamlines data pipeline creation through a structured, AI-driven workflow. By leveraging a multi-agentic framework, the system simplifies complex transformations, so that even intricate data processing logic is correctly implemented. Additionally, the inclusion of an intuitive user interface allows business users to actively participate in pipeline creation without requiring deep technical expertise. This democratization of data transformation enables faster decision-making, reduces dependency on data engineers, and ensures that business logic is accurately captured in the generated DBT code while maintaining the highest technical standards for scalability, efficiency, and correctness.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of the ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for automated generation of data pipeline code, comprising:
a processor;
a memory storing computer-executable instructions that, when executed by the processor, cause the system to:
receive multi-modal input data comprising at least one of visual data, audio data, and textual data defining desired data transformations;
instantiate a hierarchical framework comprising a plurality of specialized artificial intelligence (AI) agents, the plurality of specialized AI agents comprising a planner agent, an assembler agent, a validator agent, and a code generator agent;
process, by the planner agent incorporating a large language model and computer vision capabilities, the multi-modal input data to extract structural elements defining a pipeline architecture;
generate, by the assembler agent, a pipeline configuration by incorporating database schema information into the extracted structural elements;
validate, through a user interface, the pipeline configuration against predefined technical requirements by the validator agent; and
generate, by the code generator agent, executable Data Build Tool (DBT) code implementing the validated pipeline configuration.

2. The system of claim 1, wherein processing the multi-modal input data comprises:
processing the visual data using a visual understanding model configured to interpret pipeline diagrams;
converting the audio data to text using a speech recognition model; and
extracting transformation instructions from the textual data using a natural language processing model.

3. The system of claim 1, wherein the planner agent is configured to:
identify transformation operations from the multi-modal input data;
generate a high-level pipeline plan based on the identified transformation operations; and
receive user approval via the user interface before pipeline creation.

4. The system of claim 1, wherein the assembler agent is configured to:
dynamically query the database schema information;
configure pipeline nodes based on the queried database schema information; and
map the transformation operations between the configured pipeline nodes.

5. The system of claim 1, wherein the validator agent is configured to:
perform iterative self-assessment of the pipeline configuration;
identify pipeline inconsistencies and inefficiencies; and
verify adherence to the predefined technical requirements.

6. The system of claim 1, wherein the code generator agent is configured to:
generate structured query language (SQL) transformations in accordance with Data Build Tool (DBT) specifications;
implement scalability protocols within the SQL transformations; and
output the SQL transformations as DBT-compatible model configurations.

7. The system of claim 1 further comprises a reflection agent configured to:
execute the executable DBT code in an isolated computing environment;
detect runtime errors in the executed DBT code; and
transmit error data to the code generator agent to initiate code modification.

8. The system of claim 1, wherein the hierarchical framework further comprises a state agent configured to:
obtain agent state data from each of the plurality of specialized artificial intelligence agents;
store the agent state data comprising user inputs, agent recommendations, and human validation feedback; and
transmit the stored agent state data between the plurality of specialized artificial intelligence agents to facilitate sequential processing of the data pipeline code.

9. The system of claim 1, wherein the user interface facilitates human validation during:
a pipeline planning stage;
a pipeline assembly stage; and
a code validation stage.

10. A computer-implemented method for automated generation of data pipeline code, comprising:
receiving multi-modal input data comprising at least one of visual data, audio data, and textual data defining desired data transformations;
instantiating a hierarchical framework comprising a plurality of specialized artificial intelligence (AI) agents, the plurality of specialized AI agents comprising a planner agent, an assembler agent, a validator agent, and a code generator agent;
processing, by the planner agent incorporating a large language model and computer vision capabilities, the multi-modal input data to extract structural elements defining a pipeline architecture;
generating, by the assembler agent, a pipeline configuration by incorporating database schema information into the extracted structural elements;
validating, through a user interface, the pipeline configuration against predefined technical requirements; and
generating, by the code generator agent, executable Data Build Tool (DBT) code implementing the validated pipeline configuration.

11. The method of claim 10, wherein processing the multi-modal input data comprises:
processing the visual data using a visual understanding model configured to interpret pipeline diagrams;
converting the audio data to text using a speech recognition model; and
extracting transformation instructions from the textual data using a natural language processing model.

12. The method of claim 10, wherein the planner agent performs:
identifying transformation operations from the multi-modal input data;
generating a high-level pipeline plan based on the identified transformation operations; and
receiving user approval via the user interface before pipeline creation.

13. The method of claim 10, wherein the assembler agent performs:
dynamically querying the database schema information;
configuring pipeline nodes based on the queried database schema information; and
mapping the transformation operations between the configured pipeline nodes.

14. The method of claim 10, wherein the validator agent performs:
performing iterative self-assessment of the pipeline configuration;
identifying pipeline inconsistencies and inefficiencies; and
verifying adherence to the predefined technical requirements.

15. The method of claim 10, wherein the code generator agent performs:
generating structured query language (SQL) transformations in accordance with Data Build Tool (DBT) specifications;
implementing scalability protocols within the SQL transformations; and
outputting the SQL transformations as DBT-compatible model configurations.

16. The method of claim 10, further comprising:
executing the executable DBT code in an isolated computing environment;
detecting runtime errors in the executed DBT code; and
transmitting error data to the code generator agent to initiate code modification.

17. The method of claim 10, further comprising:
obtaining, agent state data from each of a plurality of specialized artificial intelligence agents;
storing the agent state data comprising user inputs, agent recommendations, and human validation feedback; and
transmitting the stored agent state data between the plurality of specialized artificial intelligence agents to facilitate sequential processing of the data pipeline code.

18. The method of claim 10, wherein validating through the user interface comprises facilitating human validation during:
a pipeline planning stage;
a pipeline assembly stage; and
a code validation stage.
